(19) United States
(12) Patent Application Publication
(10) Pub. No.: US 2026/0036975 A1
(43) Pub. Date: Feb. 5, 2026

(54) SYSTEMS AND METHODS FOR SUBURBAN GAS PIPELINE EMERGENCY SUPERVISION USED IN URBAN LIFELINE PROJECTS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Rui RU, Chengdu (CN)

(73) Assignee: CHENGDU QINCHUAN IOT TECHNOLOGY CO., LTD., Chengdu (CN)

(21) Appl. No.: 19/358,407

(22) Filed: Oct. 14, 2025

(30) Foreign Application Priority Data
Sep. 9, 2025 (CN) 202511279085.6

(51) Int. Cl. G05B 23/02

(52) U.S. Cl. CPC G05B 23/0267

(57) ABSTRACT

Provided is a system and a method for suburban gas pipeline emergency supervision used in an urban lifeline project, the system includes an emergency supervision and management platform and an emergency supervision object platform, and the emergency supervision and management platform is configured to: in response to completion of a remote regulation operation of a target gas pipeline, obtain a first information sequence; determine a first regulation feature based on the first information sequence and a remote regulation parameter of the remote regulation operation; determine failure probability of the remote regulation operation based on the first regulation feature; in response to the failure probability satisfying a predetermined failure condition, determine a failure cause distribution; determine a failure cause and send a control signal to the emergency supervision object platform for executing a regulation strategy based on the failure cause distribution.

### CROSS-REFERENCE TO RELATED APPLICATIONS

This application claims priority of Chinese Patent Application No. 202511279085.6, filed on Sep. 9, 2025, the entire contents of which are incorporated herein by reference.

### TECHNICAL FIELD

The present disclosure relates to the technical field of gas pipeline supervision, and in particular to a system and method for suburban gas pipeline emergency supervision used in an urban lifeline project.

### BACKGROUND

In the regulation of suburban gas pipelines, remote control is typically employed, and this regulation manner allows operators to execute control instructions from locations far away from the actual pipeline. Because the operators are not on-site, it is difficult to promptly grasp the actual operation state of the gas pipelines. Therefore, it is necessary to verify its effectiveness after each regulation, i.e., whether the expected control effect has been achieved. If the validity of the regulation cannot be accurately judged, it may lead to the system misjudging the operation state of the gas pipelines, thus failing to detect potential safety hazards in a timely manner, and could even result in gas leakage, explosions, and other serious safety incidents.

Therefore, it is necessary to provide a system and method for suburban gas pipeline emergency supervision used in an urban lifeline project, which can supervise the effectiveness of suburban gas pipeline regulation and ensure the safety of suburban gas use.

### SUMMARY

Embodiments of the present disclosure provide a system for suburban gas pipeline emergency supervision used in an urban lifeline project, the system includes an emergency supervision and management platform and an emergency supervision object platform, and the emergency supervision and management platform is configured to: in response to completion of a remote regulation operation of a target gas pipeline, obtain a first information sequence, the first information sequence including flow data and pressure data at a plurality of moments; determine a first regulation feature based on the first information sequence and a remote regulation parameter of the remote regulation operation; determine failure probability of the remote regulation operation based on the first regulation feature; in response to the failure probability satisfying a predetermined failure condition, determine a failure cause distribution, the failure cause distribution including probability distributions corresponding to a regulation device abnormality, a pipeline abnormality, and a signal transmission abnormality; determine a failure cause and send a control signal to the emergency supervision object platform for executing a regulation strategy based on the failure cause distribution, the regulation strategy including: in response to the failure cause being the regulation device abnormality, adjust a driving mode of a regulation device based on the control signal; and in response to the failure cause being the signal transmission abnormality, enable an alternate network link or a drone to serve as a temporary communication base station based on the control signal.

Embodiments of the present disclosure provide a method for suburban gas pipeline emergency supervision used in an urban lifeline project, the method being performed by the system for suburban gas pipeline emergency supervision used in the urban lifeline project, the method including: in response to completion of a remote regulation operation of a target gas pipeline, obtaining a first information sequence, the first information sequence including flow data and pressure data at a plurality of moments; determining a first regulation feature based on the first information sequence and a remote regulation parameter of the remote regulation operation; determining failure probability of the remote regulation operation based on the first regulation feature; in response to the failure probability satisfying a predetermined failure condition, determining a failure cause distribution, the failure cause distribution including probability distributions corresponding to a regulation device abnormality, a pipeline abnormality and a signal transmission abnormality; determining a failure cause and send a control signal to the emergency supervision object platform for executing a regulation strategy based on the failure cause distribution, the regulation strategy including: in response to the failure cause being the regulation device abnormality, adjusting a driving mode of a regulation device based on the control signal; and in response to the failure cause being the signal transmission abnormality, enabling an alternate network link or a drone to serve as a temporary communication base station based on the control signal.

Embodiments of the present disclosure provide a non-transitory computer-readable storage medium storing computer instructions, when reading the computer instructions in the storage medium, a computer implements the method for suburban gas pipeline emergency supervision used in the urban lifeline project.

### BRIEF DESCRIPTION OF THE DRAWINGS

The present disclosure will be further illustrated by way of exemplary embodiments, which will be described in details by means of the accompanying drawings. These embodiments are not limiting, and in these embodiments, the same counting denotes the same structure, wherein:

FIG. 1 is a schematic diagram illustrating a platform structure of a system for suburban gas pipeline emergency supervision used in an urban lifeline project according to some embodiments of the present disclosure;

FIG. 2 is an exemplary flowchart illustrating a method for suburban gas pipeline emergency supervision used in an urban lifeline project according to some embodiments of the present disclosure;

FIG. 3 is an exemplary schematic diagram illustrating an interference determination model according to some embodiments of the present disclosure; and

FIG. 4 is an exemplary flowchart illustrating a process for determining an abnormal pipeline segment according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations based on the drawings without exercising creative labor. Unless otherwise indicated or stated in the context, the same reference numerals in the drawings represent the same structures or operations. Unless the context clearly suggests an exception, “one”, “a”, and/or “the” do not refer specifically to the singular, but may also include the plural.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

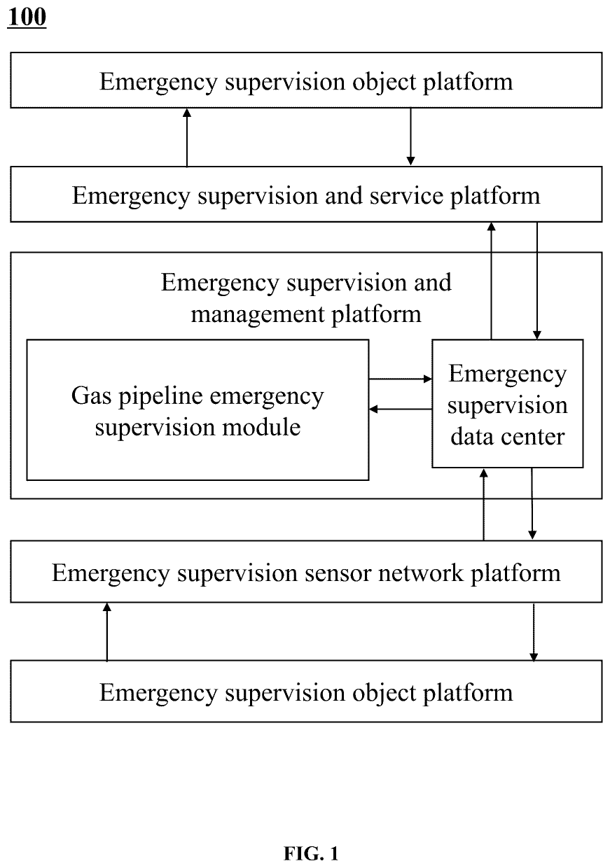

FIG. 1 is a schematic diagram illustrating a platform structure of a system for suburban gas pipeline emergency supervision used in an urban lifeline project according to some embodiments of the present disclosure.

In some embodiments, as shown in FIG. 1, the system for suburban gas pipeline emergency supervision used in the urban lifeline project (hereinafter referred to as a system 100) may include an emergency supervision user platform, an emergency supervision and service platform, an emergency supervision and management platform, an emergency supervision sensor network platform, and an emergency supervision object platform.

The emergency supervision user platform includes a superior-level emergency supervision user platform and an emergency supervision citizen user platform. The superior-level emergency supervision user platform is configured to obtain emergency supervision and management information uploaded by an emergency supervision department at a current level through the emergency supervision and management platform, and send emergency supervision instructions to the emergency supervision and management platform. For example, the superior-level emergency supervision user platform may obtain the emergency supervision and management information, such as emergency supervision events, emergency supervision disposal plans, emergency supervision risks, or the like, which is uploaded by the emergency supervision and management platform. The emergency supervision citizen user platform is configured to obtain emergency supervision early warning information. For example, the emergency supervision early warning information may include occurrence time, occurrence locations, and personal response measures of the emergency supervision events, or the like. The emergency supervision user platform includes at least one personnel interaction device. For example, the at least one personnel interaction device may include a cell phone, a computer, or the like.

The emergency supervision and service platform refers to a platform that provides service communication between the emergency supervision user platform and the emergency supervision and management platform. The emergency supervision and service platform is configured as a server or a processor.

The emergency supervision and management platform refers to a platform for the emergency supervision department at the current level to carry out comprehensive management of emergency supervision information within its management scope, the emergency supervision information including information related to an operation state of the gas pipeline. The emergency supervision and management platform is configured as a server and/or a processor, or the like. The emergency supervision and management platform further includes a gas pipeline emergency supervision module and an emergency supervision data center.

The gas pipeline emergency supervision module is configured to obtain the information related to the operation state of the gas pipeline and other related information from the emergency supervision data center, and analyze and process the information related to the operation state of the gas pipeline. The system 100 conducts targeted processing of the emergency supervision events of gas pipelines through the gas pipeline emergency supervision module.

The emergency supervision data center is configured to store information or data related to the system 100. For example, the information or data related to the system 100 may include historical pipeline maintenance data, a distribution of pipelines, etc.

The emergency supervision sensor network platform refers to a platform configured to manage emergency supervision sensing information comprehensively. The emergency supervision sensor network platform is configured as a communication network, a gateway, or the like. The emergency supervision sensor network platform may interact bidirectionally with the emergency supervision and management platform and the emergency supervision object platform.

The emergency supervision object platform refers to a platform for emergency supervision information generation and control information execution. The emergency supervision object platform includes emergency supervision devices such as a gas monitoring device, a regulation device, a drone, or the like.

The gas monitoring device refers to a device related to monitoring and recording an operation state of a gas pipeline network. The gas monitoring device may include a pressure sensor, a flow sensor, or the like. The gas monitoring device may be installed at a predetermined location of the gas pipeline. For example, the predetermined location may include a data sampling point location, a starting end of the gas pipeline, an interior of the gas pipeline, a user side, or the like. The pressure sensor is configured to collect pressure data inside the gas pipeline. The flow sensor is configured to acquire flow data inside the gas pipeline.

The regulation device refers to a device configured to control and regulate gas-related parameters in the gas pipeline network. The regulation device may include a pressure regulation controller, a gas valve, an actuator, or the like. The pressure regulation controller may be configured to regulate the gas pressure in the gas pipeline. The gas valve may be configured to control on-off of the gas flow. The actuator may be configured to drive the pressure regulation controller, the gas valve, etc., for operation.

The drone refers to a device configured to collect information related to the gas pipeline. The drone may include on-board components such as a camera, a microphone, a gas sensor, or the like. The drone may perform data collection in the vicinity of the gas pipeline to obtain multi-dimensional information related to the operation state of the gas pipeline. The camera may be configured to collect image data of the gas pipeline. The microphone may be configured to collect sound data inside the gas pipeline. The gas sensor may be configured to collect gas concentration inside the gas pipeline.

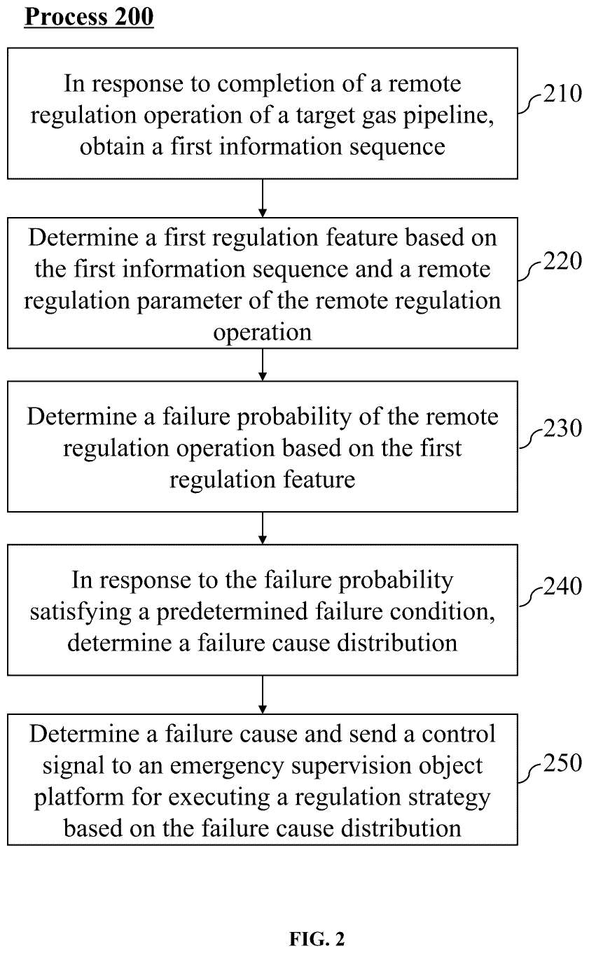

More descriptions regarding the above content may be found in FIG. 2 to FIG. 4 below and related descriptions.

Through the system 100, a closed loop of information operation between the functional platforms may be formed, and the functional platforms may be coordinated and operated regularly under the unified management of the emergency supervision and management platform, so as to realize the informatization and intelligence of the emergency monitoring of suburban gas pipeline.

FIG. 2 is an exemplary flowchart illustrating a method for suburban gas pipeline emergency supervision used in an urban lifeline project according to some embodiments of the present disclosure, a process 200 may be performed by the emergency supervision and management platform.

In 210, in response to completion of a remote regulation operation of a target gas pipeline, a first information sequence may be obtained.

The target gas pipeline refers to a gas pipeline scheduled for remote regulation within the suburban gas pipelines of the urban lifeline project. The target gas pipeline includes a pipeline area and ancillary facilities within the corresponding pipeline area, regulation point locations, or the like. The ancillary facilities may include valves, pressure regulation stations, or the like. The regulation point location refers to a specific location on the target gas pipeline where the remote regulation operation is performed. The target gas pipeline is predetermined based on actual requirements.

The remote regulation operation refers to a collection of remote regulation instructions used to regulate an operation state or parameters of a regulation device of the target gas pipeline through the system 100. The parameters of the regulation device may include a pressure, a flow rate, a valve opening, and other related data corresponding to the regulation device.

The first information sequence refers to a collection of a series of gas parameters corresponding to gas operation information collected from data sampling point locations during a monitoring time period.

In some embodiments, the first information sequence includes the gas parameters (e.g., flow data, pressure data, etc.) for a plurality of moments. The first information sequence may be represented in the form of a time series. The monitoring time period refers to at least one time period within a time period after the completion of the remote regulation operation. The monitoring time period may be preset based on historical experiences.

The data sampling point location refers to a preset specific location or node on the suburban gas pipeline, etc. The data sampling point location may be set in advance based on the historical experiences. The data sampling point location is preconfigured with sensors for data collection and other related devices.

In some embodiments, the emergency supervision and management platform may periodically collect and obtain the first information sequence during the monitoring time period by means of sensors at one or more data sampling point locations on the target gas pipeline or in a neighboring area of the target gas pipeline. The neighboring area refers to an area within a predetermined range of the target gas pipeline. For example, the data sampling point locations include downstream points in the neighboring area that are closest to the regulation point locations, etc.

In 220, a first regulation feature may be determined based on the first information sequence and a remote regulation parameter of the remote regulation operation.

The remote regulation parameter refers to a target value of an operation state or a parameter of the regulation device of the target gas pipeline predetermined under the remote regulation operation. For example, the remote regulation parameter may include at least one of a target pressure value, a target flow rate value, a valve opening, or the like.

The target pressure value refers to a desired pressure level set during a remote regulation process in the gas pipeline.

The target flow value refers to a desired rate of a gas volume or a mass flowing through the gas pipeline, which is set during the remote regulation process.

The first regulation feature refers to data used to characterize the execution effect, and response timeliness of the remote regulation operation. For example, the first regulation feature may include a regulation delay time, a regulation completion degree, etc.

The regulation delay time refers to a time difference from an issuance of the remote modulation instruction to a start of an execution of the remote regulation operation. For example, the regulation delay time may be a time difference between an issuance moment of the remote regulation instruction and a change moment of the gas parameter of the data sampling point location.

The regulation completion degree refers to a match degree between actual execution effect data of the remote regulation operation and a target execution effect at the end of the monitoring time period. For example, the regulation completion degree may be a ratio of an actual gas parameter value of the data sampling point location to the remote regulation parameter, etc.

In some embodiments, the emergency supervision and management platform may determine the first regulation feature based on the first information sequence and the remote regulation parameter of the remote regulation operation in a plurality of ways. For example, the emergency regulation and management platform may analyze and process the first information sequence and the remote regulation parameter of the remote regulation operation by means of a data analysis algorithm (e.g., a time series analysis algorithm, a regression analysis algorithm, etc.) to determine the first regulation feature.

In some embodiments, the emergency supervision and management platform may determine a data change feature based on the first information sequence; and determine the first regulation feature based on the data change feature and the remote regulation parameter.

The data change feature refers to data that characterizes a change of the gas parameter over time after the remote regulation operation. For example, the data change feature may include a steady-state value of the gas parameter, a time at which the gas parameter reaches the steady-state value, an oscillation situation of a curve of the gas parameter that reaches the steady-state value, a starting time point of data change, or the like. For example, the oscillation situation may include a frequency of an oscillation, an average amplitude of the oscillation, or the like.

The steady-state value refers to a value that characterizes the gas parameter after it has stabilized after the remote regulation operation. For example, the steady-state value may include a steady-state pressure value, a steady-state flow value, or the like.

In some embodiments, the emergency supervision and management platform may process and calculate the first information sequence using a predetermined time series analysis algorithm and other algorithms to identify, quantify, and finally obtain the data change feature. The time series analysis algorithm may include a trend analysis algorithm, a Fourier transform algorithm, statistical feature analysis (e.g., mean, variance, etc.), or the like.

In some embodiments, the emergency supervision and management platform may compare and analyze the data change feature with the remote regulation parameter to obtain the regulation delay time and the regulation completion degree. The regulation delay time and the regulation completion degree are used as the first regulation feature. For example, a difference between the starting time point of the data change and a time point at which the remote regulation instruction is issued is determined as the regulation delay time. A first ratio between the steady-state pressure value of the data change feature and the target pressure value issued by the remote regulation instruction may be determined, a second ratio between the steady-state flow value of the data change feature and the target flow value issued by the remote regulation instruction may be determined, a weighted value of the first ratio and the second ratio may be determined as the regulation completion degree. A weight coefficient is predetermined based on experiences.

By determining the data change feature based on the first information sequence and combining the first regulation feature obtained by analyzing the remote regulation parameter, the dynamic response situation of the gas pipeline of a regulation process can be more accurately reflected, which makes the judgment of the completion state of the regulation more close to the actual operation situation of the gas pipeline, which is conducive to the subsequent more accurate identification of whether the regulation reaches the expected goal, and provides a reliable basis for the subsequent optimization of a regulation strategy and the judgment of anomalies.

In 230, a failure probability of the remote regulation operation may be determined based on the first regulation feature.

The failure probability refers to a probability that an actual regulation effect of the remote regulation operation fails to reach the remote regulation parameter.

In some embodiments, the emergency supervision and management platform may determine the failure probability of the remote regulation operation by a plurality of ways. For example, the emergency supervision and management platform may determine the failure probability of the remote regulation operation by querying a first predetermined table based on the first regulation feature.

In some embodiments, the first predetermined table may include a correspondence among different ranges of regulation delay time, different ranges of regulation completion degree, and different failure probabilities. For example, the correspondence in the first predetermined table may include that, when the regulation delay time is less than or equal to 10 s and the regulation completion degree is greater than or equal to 95%, a corresponding failure probability is 5%. The first predetermined table may be constructed based on historical data, etc. For example, the first predetermined table may be constructed based on a record of the remote regulation operation with a complete regulation process and result. Exemplarily, the emergency supervision and management platform may determine a failure probability corresponding to a plurality of remote regulation operations based on the regulation delay times and the regulation completion degrees of the plurality of remote regulation operations in the historical data. When a count of the plurality of remote regulation operations is 100, the regulation delay time is less than or equal to 10 seconds, and the regulation completion degree is greater than or equal to 95, 5 of the 100 remote regulation operations fail, the corresponding failure probability is 5%.

In some embodiments, the emergency supervision and management platform may determine an interference degree based on gas usage data corresponding to the remote regulation operation and the remote regulation parameter; and determine the failure probability based on the first regulation feature and the interference degree.

The gas usage data refers to data that may reflect gas usage collected from downstream users of the target gas pipeline during the remote regulation operation. For example, the gas usage data may include an average flow value, an average pressure value, or the like, of the user during the remote regulation.

The downstream users of the gas pipeline refer to users located in a gas output direction of a pipeline segment. The downstream of the gas pipeline may also be characterized as a user-side gas pipeline.

The average flow value and the average pressure value on the user side may be obtained by the gas monitoring device of the emergency supervision object platform.

The interference degree refers to data that measures the magnitude of the impact of external factors on the effectiveness of the gas regulation. The external factors may include factors such as unexpected changes in gas usage or gas usage patterns of the downstream users. The unexpected changes may include factors such as a sudden startup of a large load device by an industrial user, a sudden turn-on of an agricultural irrigation system, etc.

In some embodiments, the emergency supervision and management platform may determine the interference degree in plurality of ways. For example, the emergency supervision and management platform may determine the interference degree by querying a second predetermined table based on the gas usage data corresponding to the remote regulation operation and the remote regulation parameter. The second predetermined table may include a correspondence between the gas usage data and the remote regulation parameter and the interference degree.

In some embodiments, the second predetermined table is constructed based on a large number of records of the remote regulation operation in the historical data. Records of historical remote regulation operation may include data such as the average flow rate value on the user side, the average pressure value on the user side, a target pressure value and a target flow rate value of the regulation, and an actual pressure value and an actual flow rate value at the time of completion of the regulation. Based on the target pressure value and the target flow rate value, the actual pressure value and the actual flow rate value, a historical interference degree is calculated and then combined with a corresponding average flow rate value on the user side, a corresponding average pressure value on the user side, a corresponding target pressure value, and a corresponding target flow rate value of the regulation to obtain a piece of data in the second predetermined table. A plurality of pieces of data in the second predetermined table is formed based on data in the plurality of records of the remote regulation operation.

In some embodiments, the historical interference degree in the process for constructing the second predetermined table may be obtained by following formula:

$$historical interference degree = {w}_{1} \cdot \frac{\vert actual pressure value - target pressure value \vert}{target pressure value} + {w}_{2} \cdot \frac{\vert actual flow value - target flow rate value \vert}{target flow rate value}$$

The coefficient w₁ and the coefficient w₂ may be set by an expert based on priori experiences.

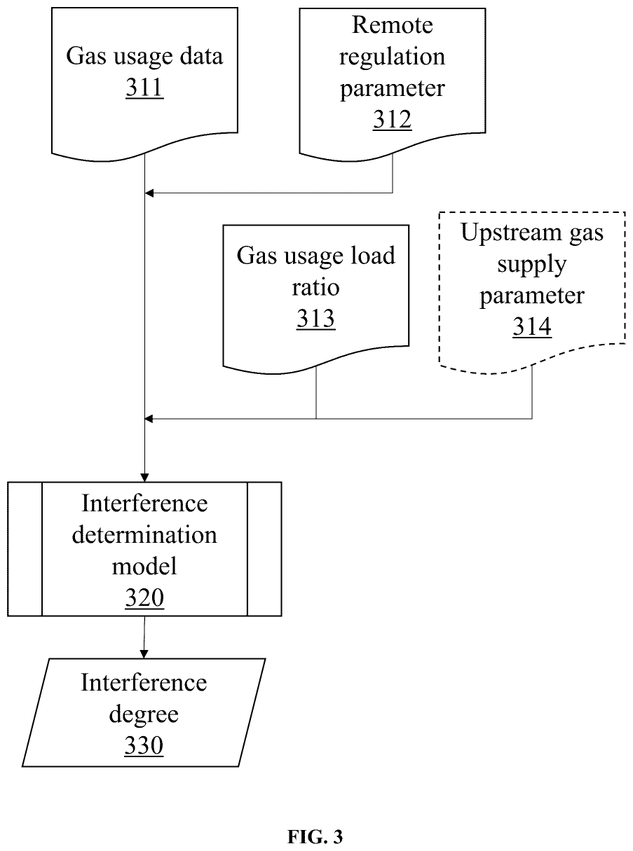

In some embodiments, the interference degree may be determined by an interference determination model. More descriptions regarding the determination of the interference degree may be found in FIG. 3 and related descriptions.

In some embodiments, the emergency supervision and management platform may determine the failure probability of the remote regulation operation based on the first regulation feature and the interference degree in a plurality of ways. For example, the emergency supervision and management platform may determine the failure probability based on the first regulation feature and the interference degree through a failure prediction model.

The failure prediction model may be a machine learning model. For example, the failure prediction model may include neural networks, other customized model structures, or any combination thereof.

In some embodiments, the failure prediction model may be obtained by training based on a large number of first training samples with a first label. The emergency supervision and management platform may input a plurality of first training samples with the first label into an initial failure prediction model, construct a loss function through the first label and results of the initial failure prediction model, and iteratively update parameters of the initial failure prediction model based on the loss function by gradient descent manner, etc. When the loss function satisfies a predetermined condition, a trained failure prediction model is obtained. The predetermined condition may include the loss function converging, a count of iterations reaching a threshold, or the like.

In some embodiments, the first training sample may include a sample first regulation feature and a sample interference degree. The first label may include an actual failure probability corresponding to the first training sample.

In some embodiments, the first training sample may be determined by the first regulation feature and the interference degree corresponding to a preferred regulation case in the historical data.

The preferred regulation case refers to remote regulation records in the historical data that have complete regulation processes and results. The complete regulation processes and results refer to historical remote regulation data that contains the first information sequence, the remote regulation parameter, the first regulation feature, and a final determination of whether the regulation is successful.

In some embodiments, the emergency supervision and management platform may count a proportion of regulation failures corresponding to a plurality of historical remote operation records when a similarity to the first training sample exceeds a predetermined threshold, and determine the proportion to be the first label of the first training sample.

By determining the interference degree based on the gas usage data corresponding to the remote regulation operation and the remote regulation parameter, and by combining the first regulation feature with the interference degree to comprehensively determine the failure probability, the system is able to more accurately differentiate between the effectiveness of the regulation and the external gas usage behavior, thus improving the accuracy of the judgment of regulation failure, avoiding misjudgment due to external interference such as fluctuations in gas use on the user side, and at the same time improving the timeliness and reliability of interference identification in the regulation process.

In some embodiments, the emergency supervision and management platform may execute remote detection regulation of the regulation point locations and upstream and downstream point locations of the target gas pipeline; in response to completion of the remote detection regulation, obtain a second information sequence; determine a second regulation feature based on the second information sequence and a detection regulation parameter of the remote detection regulation; and determine the failure probability based on the first regulation feature, the interference degree, and the second regulation feature.

The remote detection regulation refers to a remote regulation operation with a small amplitude. The small amplitude refers to a small range of parameter adjustment that does not cause significant disturbance or risk. The remote detection regulation may be used to observe an actual response of the regulation device and verify whether the system state is failed.

In some embodiments, the remote detection regulation may be executed one or more times. Execution times may be preset according to requirements.

In some embodiments, the emergency supervision and management platform may determine the execution times of the remote detection regulation based on the regulation delay time and the regulation completion degree.

In some embodiments, a predetermined correspondence exists between the regulation delay time and the regulation completion degree and the execution times of the remote detection regulation, and the execution times may be determined based on the predetermined correspondence. For example, the predetermined correspondence may include the execution times being positively correlated to the regulation delay time, and negatively correlated to the regulation completion degree.

By dynamically adjusting the execution times of the remote detection regulation, the targeting of the remote detection regulation can be effectively improved, which is conducive to improving the accuracy of the subsequent determination of the failure probability.

In some embodiments, the emergency supervision and management platform may determine a regulation amplitude of the remote detection regulation based on the interference degree and a sensor invalid zone.

The sensor invalid zone refers to a smallest range of regulation changes that the sensor may not sense or respond to. When an amount of sensor input change in the remote detection regulation process is lower than a sensing threshold, the amount of sensor input change is in the sensor invalid zone, and the output of the sensor does not change. The sensing threshold may be preset based on priori experiences.

The regulation amplitude refers to a parameter change value of the remote detection regulation. The regulation amplitude is positively correlated to the interference degree and the sensor invalid zone. For example, the greater the interference degree and the greater the range of the sensor invalid zone, the greater the regulation amplitude.

By dynamically adjusting the regulation amplitude of the remote detection regulation, the targeting of the remote detection regulation can be further improved, which is conducive to further improve the accuracy of the subsequent determination of the failure probability.

In some embodiments, at the regulation point locations and/or adjacent upstream and downstream point locations of the regulation point locations, the emergency supervision and management platform may carry out the remote detection regulation a plurality of times and obtain a corresponding second information sequence. The upstream and downstream point locations refer to upstream and downstream point locations of the regulation point locations on the target gas pipeline.

The second information sequence refers to a collection of a series of gas parameters corresponding to the gas operation information collected from the regulation point locations and adjacent upstream and downstream point locations after the completion of the remote detection regulation. The second information sequence is obtained in a similar manner as the first information sequence. More description regarding the manner of obtaining the second information sequence may be found in step 210 above and the related descriptions.

The detection regulation parameter refers to a target value of an operation state or parameter of the regulation device of the target gas pipeline under the remote detection regulation.

The second regulation feature refers to data used to characterize an execution effect and response timeliness of the remote detection regulation. For example, the second regulation feature may include a response delay time, a response completion degree, a response amplitude, etc.

The response delay time refers to a time difference from an issuance of a remote detection regulation instruction to a start of an execution of the remote detection regulation.

The response completion degree refers to a match degree of an actual execution effect and a target execution effect of the remote detection regulation. For example, the response completion degree may be a ratio of actual gas parameter values at the regulation point locations and the adjacent upstream and downstream point locations to the detection regulation parameter.

The response amplitude refers to a change amplitude of the gas parameter at the regulation point locations and the adjacent upstream and downstream point locations after executing the remote detection regulation. The response amplitude may be obtained by counting change values of the gas parameters at the regulation point locations and the adjacent upstream and downstream point locations.

In some embodiments, the emergency supervision and management platform may determine the second regulation feature based on the second information sequence in a plurality of ways. The process for determining the second regulation feature is similar to that for determining the first regulation feature, more descriptions may be found in step 220 above and the related descriptions.

In some embodiments, the emergency supervision and management platform may determine the failure probability in a plurality of ways based on the first regulation feature, the interference degree, and the second regulation feature. For example, the emergency supervision and management platform may calculate a difference between the second regulation feature and a response baseline value, in response to the difference being greater than a threshold value, determining a deviation degree of the second regulation feature. The failure probability is positively correlated to the deviation degree, the regulation delay time, and the interference degree, and the failure probability is negatively correlated to the regulation completion degree.

The response baseline value refers to a standardized reference value of the second regulation feature. The response baseline value and the threshold value may be preset based on priori experiences. The deviation degree refers to a difference amplitude between the second regulation feature and the response baseline value. The deviation degree may be obtained by a ratio of the difference to the response baseline value.

Without causing significant disturbance or risk, the failure probability of the remote regulation operation is determined by conducting remote detection regulation, which further improves the accuracy with which failure probability is determined by the system.

In 240, in response to the failure probability satisfying a predetermined failure condition, a failure cause distribution is determined.

The predetermined failure condition refers to a condition used to determine whether further investigation needs to be initiated. The predetermined failure condition may be a failure probability being greater than a first threshold, etc. The first threshold refers to a critical minimum value of the failure probability that triggers the initiation of the further investigation. The predetermined failure condition and the first threshold value may be manually preset based on priori experiences.

The failure cause distribution refers to a probability distribution of causes that lead to a failure of the remote regulation operation. The failure cause distribution may include probability distributions corresponding to a regulation device abnormality, a pipeline abnormality, a signal transmission abnormality, or the like, respectively.

In some embodiments, in response to the failure probability satisfying the predetermined failure condition, the emergency supervision and management platform may determine the failure cause distribution in a plurality of ways. For example, the emergency supervision and management platform may determine the failure cause distribution based on the failure probability by querying the first predetermined table.

In some embodiments, the parameter in the first predetermined table further includes the failure probability and a corresponding failure cause distribution. For example, in response to the first threshold being 50%, the emergency supervision and management platform may add a column corresponding to the failure cause distribution to the first predetermined table, and count rows corresponding to the failure probability greater than 50% in the first predetermined table. The emergency supervision and management platform may count a count of the regulation device abnormalities, a count of the pipeline abnormalities, and a count of the signal transmission abnormalities that correspond to the failure cause distribution greater than 50%, respectively, in the historical data, and calculate a ratio thereof to the total count of failures, the failure cause distribution is then obtained and filled into the first predetermined table.

In 250, a failure cause may be determined and a control signal may be sent to the emergency supervision object platform for executing a regulation strategy based on the failure cause distribution.

In some embodiments, the emergency supervision and management platform may determine an anomaly with the largest probability distribution in the failure cause distribution as the failure cause.

The control signal refers to a instruction signal sent by the emergency supervision and management platform to the emergency supervision object platform based on the failure cause. In some embodiments, a predetermined correspondence exists between the control signal and the failure cause. The regulation strategy refers to a specific control manner generated by the emergency supervision and management platform based on the failure cause.

In some embodiments, in response to the failure cause being the regulation device abnormality, the regulation strategy may be adjusting a driving mode of the regulation device based on the control signal. For example, the driving mode of the regulation device may be switched from electromagnetic drive to hydraulic drive, etc.

In some embodiments, in response to the failure cause being the signal transmission abnormality, the regulation strategy may be activating an alternate network link or a drone to serve as a temporary communication base station based on the control signal.

The alternate network link refers to an additional network link that is activated when the existing network link is abnormal. The temporary communication base station refers to a base station that is temporarily used to receive and transmit signals.

By determining the failure probability based on the first regulation feature, and further determining the failure cause distribution, the control signal is send to the emergency supervision object platform to execute a corresponding regulation strategy based on different failure causes. It can realize monitoring the pipeline operation under the remote regulation state, judgment of regulation effect and abnormal response, thereby enhancing the remote regulation capability of the pipeline network and the efficiency of emergency response, and improving the effectiveness of suburban gas pipeline regulation and ensuring the safety of suburban gas use.

FIG. 3 is an exemplary schematic diagram illustrating an interference determination model according to some embodiments of the present disclosure.

In some embodiments, the emergency supervision and management platform determines an interference degree 330 by a interference determination model 320 based on gas usage data 311, a remote regulation parameter 312, and a gas usage load ratio 313. More descriptions regarding the gas usage data, the remote regulation parameter, the interference degree, or the like, may be found in FIG. 2 and the related descriptions.

The gas usage load ratio refers to a proportion of gas load of different types of users in a total gas load. The types of users may include industrial users, commercial users, residential users, etc. The types of users corresponding to the different user sides are known. In some embodiments, the emergency supervision and management platform may obtain flow values of the different types of users based on flow values corresponding to the different user sides by real-time collection of the flow values of the user sides, and calculate a ratio of the flow values of the different types of users to a total flow value to obtain the gas usage load ratio.

The interference determination model refers to a model for determining influence of factors such as gas usage behavior of the user and other related factors on the interference degree of the remote regulation operation.

In some embodiments, the interference determination model may be a machine learning model. For example, the interference determination model may be a neural network model, other customized modeling structures, or any combination thereof.

In some embodiments, the interference determination model may be obtained by training with second training samples. The second training samples includes a plurality of second training samples with second labels. The second training samples include sample gas usage data, a sample remote regulation parameter, and a sample gas usage load ratio, and the second labels include actual interference degrees corresponding to the second training samples.

In some embodiments, the second training samples and the second labels may be obtained based on the historical data. For example, the emergency supervision and management platform may use the gas usage data, the remote regulation parameter, and the gas usage load ratio of the plurality of preferred regulation cases in the historical data as the second training samples, and the corresponding actual interference degrees as the second labels. The actual interference degree is determined in the same way as the historical interference degree is determined in FIG. 2. More descriptions regarding the preferred regulation case may be found in FIG. 2 and the related descriptions. A training process of the interference determination model is similar to that of the failure prediction model, and more descriptions regarding the training process of the interference determination model may be found in FIG. 2 and the related descriptions.

In some embodiments, an input of the interference determination model further includes an upstream gas supply parameter 314.

The upstream gas supply parameter refers to a gas operating parameter at an upstream gas supply source or an upstream key node of the target gas pipeline during the remote regulation operation. For example, the upstream gas supply parameter may include pressure data, flow data, or the like. The upstream key node may be preset based on priori experiences.

In some embodiments, the emergency supervision and management platform may obtain the upstream gas supply parameter through sensors deployed at a point of intersection of the target gas pipeline and a superior-level pipeline network, at an upstream key node, etc.

In some embodiments, when the input of the interference determination model includes the upstream gas supply parameter, the second training samples may also include a sample upstream gas supply parameter.

Through the upstream gas supply parameter, the influence of the change in user gas usage and the change in upstream gas supply on the effect of the regulation, respectively, can be effectively differentiated, thereby further improving the accuracy of the interference degree, which can more objectively assess the true effectiveness of the regulation operation, and help to improve the scientific nature of emergency response decision-making and the overall safety and efficiency of the gas network operation.

In some embodiments, the interference determination model may be updated periodically. A period may be manually predetermined based on priori experiences. For example, the period update may occur every 30 days, etc.

In some embodiments, the period may also be negatively correlated to a change magnitude of the gas usage load ratio of the industrial users. For example, the greater the change magnitude of the gas usage load ratio, the shorter the period, which in turn ensures the accuracy and timeliness of the interference degree determined by the interference determination model.

The change magnitude of the gas usage load ratio refers to a fluctuation of the gas usage load ratio for the industrial users during a previous statistical period. In some embodiments, the change magnitude of the gas usage load ratio may be obtained by calculating a standard deviation of the gas usage load ratio of the industrial users during the previous statistical period. The interference determination model is updated with the second training samples and the second labels for training based on latest historical data to perform the period update. The emergency supervision object platform may collect the latest historical data (e.g., within the previous statistical period, etc.) in real-time via sensors, etc., and the emergency supervision and management platform may process the latest historical data via a processor and train the interference determination model, then perform the period update.

In some embodiments, in response to the change magnitude of gas usage load ratio satisfying an update condition, the emergency supervision and management platform may update the predetermined table for determining the interference degree.

The predetermined table for determining the interference degree refers to the second predetermined table involved in FIG. 2. Further description of the second preset table can be found in FIG. 2.

The update condition refers to a condition used to determine whether the second predetermined table needs to be updated. In some embodiments, the update condition is the change magnitude the of the gas usage load ratio of the industrial users being greater than a second threshold. The second threshold refers to a critical value of the change magnitude of the gas usage load ratio of the industrial users. The update condition and the second threshold may be preset based on priori experiences.

In some embodiments, in response to the change magnitude of the gas usage load ratio of the industrial users in the previous statistical period satisfying the update condition, the emergency supervision and management platform may update the second predetermined table for determining the interference degree via the interference determination model.

In some embodiments, the emergency supervision and management platform may obtain a plurality of sets of data within the previous statistical period, each set of data including historical gas usage data, a historical remote regulation parameter, and historical gas usage load ratio data for the different types of users. The interference degree data corresponding to the each set of data is obtained by running the interference determination model in a plurality of times.

The plurality of sets of data and the corresponding interference degree data are sequentially filled into the second predetermined table, thereby updating the second predetermined table. The data filled into the second predetermined table does not include the historical gas usage load ratio data.

Determining the interference degree by means of the interference determination model can accurately identify abnormal interference in regulation and improve the precision of judgment. Updating the second predetermined table based on the interference determination model further improves the timeliness and accuracy of interference identification in the regulation process.

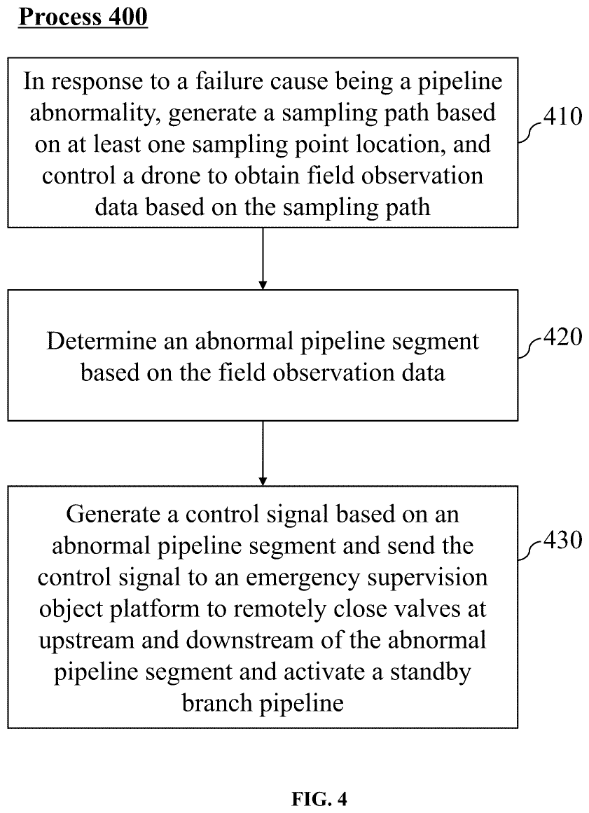

FIG. 4 is an exemplary flowchart illustrating a process for determining an abnormal pipeline segment according to some embodiments of the present disclosure. A process 400 may be performed by the emergency supervision and management platform.

In 410, in response to a failure cause being a pipeline abnormality, a sampling path may be generated based on at least one sampling point location, and a drone is controlled to obtain field observation data based on the sampling path.

The sampling point location refers to a location or a node on the target gas pipeline that is used to collect gas-related information. For example, the sampling point location includes the regulation point location and a point location in its surrounding area, etc. For example, the sampling point location include a critical zone where the pipeline abnormality is likely to exist, a critical facility node, or the like. The critical facility node may include a valve, a regulation pressure station, a pipeline branching outlet, etc. The sampling point location may be preset.

In some embodiments, based on the analysis of historical failure data of the gas pipeline, a critical area where a failure has occurred or is prone to an abnormality is identified, and the point location in the critical area, the regulation point locations, and point locations in surrounding areas may be determined as the sampling point locations.

The sampling path refers to a route plan generated based on the sampling point location. The sampling path may be used to guide the flight path of the drone.

In some embodiments, the sampling path may be obtained by the emergency supervision and management platform through a path planning algorithm, or the like. For example, the path planning algorithm may include any one or a combination of the Dijestra algorithm, the A-star algorithm, or other customized path planning algorithms.

The field observation data refers to information that reflects an actual situation of the sampling point location. For example, the field observation data may include at least one of image data, target gas concentration data, acoustic data, or the like.

The image data refers to visualization data that may reflect a situation at the site.

The target gas concentration data refers to concentration values of specific gas components (e.g., methane, etc.) in air in the vicinity of the sampling point location.

The acoustic data refers to an acoustic signal of a field environment at the sampling point location. For example, the acoustic data may include gas leakage sound, ruptured pipeline sound, or the like.

In some embodiments, the emergency supervision and management platform may collect data in the vicinity of the sampling point location as the field observation data based on the sampling path by the drone, which in turn uploads the field observation data to the emergency supervision and management platform in real-time.

In 420, an abnormal pipeline segment is determined based on the field observation data.

The abnormal pipeline segment refers to a pipeline segment with abnormal conditions in the suburban gas pipeline network. The abnormal conditions may include at least one of physical damage, gas leakage, device failure, or the like.

In some embodiments, if a degree of an abnormality (such as a breakage, a deformation, a leakage trace, etc.) on a surface of the pipeline segment is higher than a severe damage threshold, and/or the gas concentration is higher than a leakage concentration threshold, and/or a sound pressure level of the gas leakage sound is higher than a leakage sound pressure threshold, the emergency supervision and management platform marks the corresponding pipeline segment as an abnormal pipeline segment.

The severe damage threshold, the leakage concentration threshold, and the leakage sound pressure threshold may be preset based on experiences.

The degree of abnormality characterizes a severity degree of the breakage, the deformation, the leakage trace, or the like. The emergency supervision and management platform may determine the degree of abnormality (such as the breakage, the deformation, the leakage trace, etc.) on the surface of the pipeline segment based on the image data through an image recognition technology.

In some embodiments, the emergency supervision and management platform may determine the abnormal pipeline segment based on the field observation data and the second regulation feature.

In some embodiments, in order to ensure that the determination of the abnormal pipeline segment is more accurate, the emergency supervision and management platform determines the abnormal pipeline segment based on the field observation data and the second regulation feature. For example, if the degree of an abnormality (such as the breakage, the deformation, the leakage trace, ore the like) on the surface of the pipeline segment is lower than the severe damage threshold, or the gas concentration is lower than the leakage concentration threshold, or the sound pressure level of the gas leakage sound is lower than the leakage sound pressure threshold, it is still necessary to further assess whether the corresponding second regulation feature is abnormal. If the second regulation feature is confirmed to be abnormal, the pipeline segment is marked as the abnormal pipeline segment.

The second regulation feature being abnormal indicates that the response delay time, the response completion, and the response amplitude in the second regulation feature exceed the corresponding abnormality degree threshold. The abnormality degree threshold may be set based on priori experiences.

The severe damage threshold, the leakage concentration threshold, and the leakage sound pressure threshold may be preset based on priori experiences.

Determination of the abnormal pipeline segment by the field observation data and the second regulation feature compensates limitations of remote monitoring data and improves the accuracy of the determined abnormal pipeline segment.

In 430, a control signal may be generated based on the abnormal pipeline segment and the control signal may be send to the emergency supervision object platform to remotely close valves at upstream and downstream of the abnormal pipeline segment and activate a standby branch pipeline.

The standby branch pipeline refers to one or more alternative gas supply paths that are set up in advance. A gas supply route may be quickly switched through the standby branch pipeline.

By automatically generating the sampling path in response to the failure cause being the pipeline abnormality and utilizing the drone to obtain the field observation data, it is possible to quickly and accurately identify the abnormal pipeline segment. According to the generation of the control signal, the valves at upstream and downstream of the abnormal pipeline segment are remotely closed, and the standby branch pipeline is activated, which not only improves the failure response rate and positioning accuracy, but also ensures the continuity of the gas supply, effectively reduces the risk of service interruption due to pipeline failures, and improves the safety and reliability of the overall gas pipeline network operation.

The present disclosure also provides a non-transitory computer-readable storage medium storing computer instructions, when reading the computer instructions in the storage medium, a computer implements the method for suburban gas pipeline emergency supervision used in the urban lifeline project as described in any one of the aforementioned embodiments.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Finally, it should be understood that the embodiments described in the present disclosure are used only to illustrate the principles of the exemplary embodiments of the present disclosure. Other deformations may also fall within the scope of the disclosure. Therefore, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A system for suburban gas pipeline emergency supervision used in an urban lifeline project, wherein the system comprises an emergency supervision and management platform and an emergency supervision object platform, and the emergency supervision and management platform is configured to:
in response to completion of a remote regulation operation of a target gas pipeline, obtain a first information sequence, the first information sequence including flow data and pressure data at a plurality of moments;
determine a first regulation feature based on the first information sequence and a remote regulation parameter of the remote regulation operation;
determine a failure probability of the remote regulation operation based on the first regulation feature;
in response to the failure probability satisfying a predetermined failure condition, determine a failure cause distribution, the failure cause distribution including probability distributions corresponding to a regulation device abnormality, a pipeline abnormality, and a signal transmission abnormality;
determine a failure cause and send a control signal to the emergency supervision object platform for executing a regulation strategy based on the failure cause distribution, the regulation strategy including:
in response to the failure cause being the regulation device abnormality, adjust a driving mode of a regulation device based on the control signal; and
in response to the failure cause being the signal transmission abnormality, enable an alternate network link or a drone to serve as a temporary communication base station based on the control signal.

2. The system of claim 1, wherein the emergency supervision and management platform is further configured to:
determine a data change feature based on the first information sequence; and
determine the first regulation feature based on the data change feature and the remote regulation parameter.

3. The system of claim 1, wherein the emergency supervision and management platform is further configured to:
determine an interference degree based on gas usage data corresponding to the remote regulation operation and the remote regulation parameter; and
determine the failure probability based on the first regulation feature and the interference degree.

4. The system of claim 3, wherein the emergency supervision and management platform is further configured to:
determine the interference degree through an interference determination model based on the gas usage data, the remote regulation parameter, and a gas usage load ratio, the interference determination model being a machine learning model; and
in response to a change magnitude of the gas usage load ratio satisfying an update condition, update a predetermined table corresponding to determination of the interference degree.

5. The system of claim 4, wherein an input of the interference determination model further includes an upstream gas supply parameter.

6. The system of claim 3, wherein the emergency supervision and management platform is further configured to:
execute remote detection regulation of regulation point locations and upstream and downstream point locations of the target gas pipeline;
in response to completion of the remote detection regulation, obtain a second information sequence;
determine a second regulation feature based on the second information sequence and a detection regulation parameter of the remote detection regulation; and
determine the failure probability based on the first regulation feature, the interference degree, and the second regulation feature.

7. The system of claim 6, wherein the emergency supervision and management platform is further configured to: determine execution times of the remote detection regulation based on a regulation delay time and a regulation completion degree.

8. The system of claim 6, wherein the emergency supervision and management platform is further configured to: determine a regulation amplitude of the remote detection regulation based on the interference degree and a sensor invalid zone.

9. The system of claim 1, wherein the emergency supervision and management platform is further configured to:
in response to the failure cause being the pipeline abnormality, generate a sampling path based on at least one sampling point location, and control the drone to obtain field observation data based on the sampling path;
determine an abnormal pipeline segment based on the field observation data; and
generate the control signal based on the abnormal pipeline segment and send the control signal to the emergency supervision object platform to remotely close valves at upstream and downstream of the abnormal pipeline segment and activate a standby branch pipeline.

10. The system of claim 9, wherein the emergency supervision and management platform is further configured to: determine the abnormal pipeline segment based on the field observation data and a second regulation feature.

11. A method for suburban gas pipeline emergency supervision used in an urban lifeline project, the method being performed by a system for suburban gas pipeline emergency supervision use in an urban lifeline project, the method comprising:
in response to completion of a remote regulation operation of a target gas pipeline, obtaining a first information sequence, the first information sequence including flow data and pressure data at a plurality of moments;
determining a first regulation feature based on the first information sequence and a remote regulation parameter of the remote regulation operation;
determining failure probability of the remote regulation operation based on the first regulation feature;
in response to the failure probability satisfying a predetermined failure condition, determining a failure cause distribution, the failure cause distribution including probability distributions corresponding to a regulation device abnormality, a pipeline abnormality and a signal transmission abnormality;
determining a failure cause and send a control signal to the emergency supervision object platform for executing a regulation strategy based on the failure cause distribution, the regulation strategy including:
in response to the failure cause being the regulation device abnormality, adjusting a driving mode of a regulation device based on the control signal; and
in response to the failure cause being the signal transmission abnormality, enabling an alternate network link or a drone to serve as a temporary communication base station based on the control signal.

12. The method of claim 11, wherein the determining a first regulation feature based on the first information sequence and a remote regulation parameter of the remote regulation operation includes:
determining a data change feature based on the first information sequence; and
determining the first regulation feature based on the data change feature and the remote regulation parameter.

13. The method of claim 11, wherein the determining failure probability of the remote regulation operation based on the first regulation feature includes:
determining an interference degree based on gas usage data corresponding to the remote regulation operation and the remote regulation parameter; and
determining the failure probability based on the first regulation feature and the interference degree.

14. The method of claim 13, wherein the method further comprises:
determining the interference degree through an interference determination model based on the gas usage data, the remote regulation parameter, and a gas usage load ratio, the interference determination model being a machine learning model; and
in response to a change magnitude of the gas usage load ratio satisfying an update condition, updating a predetermined table corresponding to determination of the interference degree.

15. The method of claim 14, wherein an input of the interference determination model further includes an upstream gas supply parameter.

16. The method of claim 13, wherein the method further comprises:
executing remote detection regulation of regulation point locations and upstream and downstream point locations of the target gas pipeline;
in response to completion of the remote detection regulation, obtaining a second information sequence;
determining a second regulation feature based on the second information sequence and a detection regulation parameter of the remote detection regulation; and
determining the failure probability based on the first regulation feature, the interference degree, and the second regulation feature.

17. The method of claim 16, wherein the method further comprises: determining execution times of the remote detection regulation based on a regulation delay time and a regulation completion degree.

18. The method of claim 16, wherein the method further comprises: determining a regulation amplitude of the remote detection regulation based on the interference degree and a sensor invalid zone.

19. The method of claim 11, wherein the determining a failure cause and send a control signal to the emergency supervision object platform for executing a regulation strategy based on the failure cause distribution, the regulation strategy including:
in response to the failure cause being the pipeline abnormality, generating a sampling path based on at least one sampling point location, and controlling the drone to obtain field observation data based on the sampling path;
determining an abnormal pipeline segment based on the field observation data; and
generating the control signal based on the abnormal pipeline segment and sending the control signal to the emergency supervision object platform to remotely close valves at upstream and downstream of the abnormal pipeline segment and activate a standby branch pipeline.

20. A non-transitory computer-readable storage medium storing computer instructions, wherein when reading the computer instructions in the storage medium, a computer implements the method of claim 11.
